(19) United States
(12) Patent Application Publication
(10) Pub. No.: US 2018/0293318 A1
(43) Pub. Date: Oct. 11, 2018

(54) Methods And Systems For Determining People You Should Know and Autonomous Social Coaching

(71) Applicants: Mohammad Mahdi Ghassemi, Cambridge, MA (US); Tuka Alhanai, Abu Dhabi (AE)

(72) Inventors: Mohammad Mahdi Ghassemi, Cambridge, MA (US); Tuka Alhanai, Abu Dhabi (AE)

(21) Appl. No.: 15/482,487

(22) Filed: Apr. 7, 2017

(51) Int. Cl. G06F 17/30; G06F 7/02

(52) U.S. Cl. CPC G06F 17/30867; G06F 7/026

(57) ABSTRACT

The invention provides users with suggestions on other users that they should meet, who they would not have been likely to meet without such a suggestion. The invention optimizes the a-priori likelihood of positive interactions between such users by suggesting meeting locations, times, and topics of conversation. The invention optimizes the real-time interaction between users using sensors that capture one or more modalities of data and provides real-time feedback to users via one or more digital devices. The invention optimizes user's future interactions by providing retrospective analyses of prior interactions, and accompanying recommendations for how to optimize ongoing or future interactions.

### CROSS-REFERENCE TO RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC

Not applicable

### STATEMENT REGARDING PRIOR DISCLOSURES BY INVENTORS

Not Applicable

### FIELD

The invention is generally related to social networking systems. More specifically, the invention is related to methods for expanding and improving social networks. In particular, the invention is instantiated as a computer-implemented methodology on a system.

### BACKGROUND OF THE INVENTION

Individuals form new social relationships through a variety of means including: spontaneous interpersonal interactions, introductions via their existing social network, or though virtual interactions online. For instance, an individual that is looking to expand their social network may strike up a conversation in an elevator, invite a co-worker out for lunch or join an on-line interest group.

Existing social networking methodologies help users manage their existing social relationships, identify new romantic relationships, or connect with new groups of people that share common interests. The invention herein describes a methodology that facilitates long-term, platonic, in-person interactions between two or more users. The methodology is distinguished from existing approaches by providing both real-time and retrospective feedback to users on the quality of their interactions, with the goal of improving relationship quality.

Existing social networking platforms such as Facebook, LinkedIn and Downforlunch cater to users that want to curate, monitor, and/or manage their existing social networks. An individual's contacts on such platforms are often added by the user via manual search, or through affirmation of the platform's suggested connections. Existing social networking platforms suggest connections with individuals that a user is likely to already know outside the platform. The invention herein is further distinguished from existing approaches by suggesting connections with individuals that a user is not likely to know outside the platform, but who is likely to become a new social relationship after an arranged, in-person meeting.

Existing platforms that arrange new, in-person social relationships, such as Tinder, Match and eHarmony, provide connections with individuals that a user is not likely to know outside the platform, but who is likely to become a new romantic relationship after an arranged, in-person meeting. The invention herein is further distinguished from existing approaches by suggesting connections with individuals that a user is not likely to know outside the platform, but who are likely to become a new platonic relationship after an arranged, in-person meeting.

Existing platforms, such as Meetup, provide indirect connections between users and groups of other users that share common interests. Such platforms recommend groups that a user is likely to enjoy, but require users to manually identify and form social relationships with specific individuals within those groups. The invention herein is further distinguished from existing approaches by directly suggesting individuals that a user should meet, irrespective of shared group affiliations.

### RELATED PRIOR DISCLOSURES

Prior methods have been described for scoring established social relationships (US20090271370A1, US20100281035A1, US20140114774). Existing methods can also (US20100281035A1, US20140114774) determine who users may already know in the physical world, with the goal of connecting them through a digital platform. To our knowledge, all prior methods that evaluate the compatibility between individuals, and others outside their existing social networks, score compatibility for the purpose of romantic engagements (US20060059147, US20070073687). Furthermore, to our knowledge, most of the existing methods that introduce individuals to each other (U.S. Pat. No. 6,480,885, U.S. Pat. No. 7,454,357, U.S. Pat. No. 8,583,563, US20050021750, US20060059147, US20060085419, US20060106780, US20070073687, U.S. Pat. No. 8,935,331) do not attempt to actively improve these relationships in-real time through any means (direct feedback, encouraging re-introductions, etc). One prior method, that does provides feedback on how to improve future interactions does so in the context of romantic relationships (US20070073687), and requests this feedback directly from the involved parties, after they've met. To our knowledge, most of the prior methods that introduce individuals do not provide suggestions on locations or times that individuals should meet (U.S. Pat. No. 6,480,885, U.S. Pat. No. 7,454,357, U.S. Pat. No. 8,583,563, U.S. Pat. No. 8,935,331, US20050021750, US20060059147, US20060085419, US20060106780, US20070073687, US20100281035A1, U.S. Pat. No. 8,935,331) although one method defines a digital medium as the means of interaction, such as video-conferencing (US20060106780). Prior methods exist to evaluate real-time interactions between individuals such as: monitoring and assessment of communication style by a third party (US20110054985), assessment of the level of understanding between spoken interactions (US20110282669A1), and multi-party conversations (US20070071206, US20070121824). To our knowledge, none of the existing methods seek to actively improve an individual's communication style through real-time intervention, nor do these methods perform within the context of connecting individuals for repeated, platonic, long-term interactions. Several prior methods exist to provide actionable recommendations to participating users (US20040213402, US20080167878, WO2010151437A1, WO2014070238A1, WO2015091223A1, U.S. Pat. No. 6,959,080, U.S. Pat. No. 8,019,050) in the context of improving immediate aspects of an interaction.

Prior art in the form of research studies exist that quantify emotion in a social interaction [Koolagudi et al. (2012)] and provide real-time feedback on such interactions [Damian et. al (2015)]. Other work models the scheduling of joint social activities of individuals conditioning on travel time [Ronald et al. (2012)], while [Marsella et al. (2004)] models how individuals interact in various social situations. To our knowledge, none of the prior art describes an end-to-end system to establish connections between unknown individuals, for a platonic, long-term relationship.
Koolagudi, Shashidhar G., and K. Sreenivasa Rao. “Emotion recognition from speech: a review.” International journal of speech technology 15.2 (2012): 99-117.
Damian, Ionut, et al. “Augmenting social interactions: Realtime behavioural feedback using social signal processing techniques.” Proceedings of the 33rd Annual ACM Conference on Human Factors in Computing Systems. ACM, 2015.
Ronald, Nicole, Theo Arentze, and Harry Timmermans. “Modeling social interactions between individuals for joint activity scheduling.” Transportation Research Part B: Methodological 46.2 (2012): 276-290.
Marsella, Stacy C., David V. Pynadath, and Stephen J. Read. “PsychSim: Agent-based modeling of social interactions and influence.” Proceedings of the international conference on cognitive modeling. Vol. 36. 2004.

The invention described herein is distinguished from prior methods by connecting individuals with others outside their existing social network for platonic engagements. The invention is further distinguished from prior methods by providing real-time and retrospective assessments of the on-going interactions between users, with the aim of improving the quality of interactions and/or relationships between users. Furthermore, the invention described herein is distinguished from existing methods by specifying a physical place and time for the individuals to meet, while jointly optimizing for positive outcome of the short-term interaction and an increased probability of future interactions. Unlike the afore mentioned platforms and disclosures, the invention herein provides real-time analytics on the nature of the on-going interaction between users. The invention uses data from one or more sensor technologies, to assess the quality of the real-time interactions, and provide users with feedback that empowers them to improve the quality of the social interaction.

### BRIEF SUMMARY OF THE INVENTION

The disclosed invention provides a method for introducing previously unknown individuals into a given user's existing social network, suggesting one or more times for meeting, one or more locations for meeting and one or more conversational topics. Furthermore, the disclosed invention provides a method for monitoring user's interactions in real-time using one or more sensor technologies that parameterize the physiological and auditory activity of users during their meeting. Furthermore, the disclosed invention provides a method for providing real-time feedback during meetings, and retrospective analytics of prior interactions to maximize the likelihood of repeated future interactions between users, and new individuals.

Introductions between users are generated asynchronously by the request of a user, and/or periodically by the method at a rate indicated by a user. To generate introductions, the method first computes several scores that profile users. Then, for each user, the method identifies a mathematical function that combines the collected scores to generate a probabilistic estimate of how likely a given user is to enjoy a platonic social interaction with any other user. Introductions are generated by the method through identification of user pairs that jointly maximize the predicted probability of platonic social interaction success while jointly minimizing the predicted probability of prior contact between the users. Initially this mathematical model assumes that the predictors of platonic social interaction success of a new user will be similar to those of existing users that share similar traits. These assumptions are revised over time, as individuals attend an increasing number of meetings, and provide feedback to the method on their perceived quality of the introductions.

The first score used in the mathematical function estimates overlapping temporal availability between pairs of users. Temporal availability may be specified actively by the user, or passively through monitoring of a secondary digital calendar application. An additional score is assigned to each user pair that reflects the estimated time required to travel from one or more user's location, to the other user's location. User locations may be specified actively by the user, or passively through the monitoring of their GPS coordinates. An additional score is assigned to each user pair that estimates the polarity and magnitude of social connectivity. This score is quantified through one or more data streams (text, email, phone calls, prior introductions, reviews of prior meetings) that gauge prior communication levels between the users. An additional score is assigned to each user pair that estimates the platonic nature of the social connections. This score is quantified through one or more data streams (text, email, phone calls, and/or reviews of prior meetings) that seek evidence of non-platonic interactions between the users. An additional vector of scores is assigned to each user pair that measures the similarity between users with respect to data that was either volunteered to the algorithm directly by the users, made publicly available on the Internet, or inferred by the method on the basis of the user's prior interactions. For example, this vector could include, but is not limited to: religion, ideological outlook, socioeconomic status, education level, profession, race, gender, age, sexual orientation, food preferences/restrictions, general interests, and/or personality type.

Using the collected scores, the method identifies pairs of users that should be introduced. Next, the method generates a set of suggested venues for a meeting. To do this, candidate venues are identified by locating the set of venue(s) closest to the GPS coordinates linearly midway between the pair. From the set of identified candidate venues, the subset of venues with the highest estimated rating, lowest estimated wait time, and food-type that is jointly preferred by the pair are suggested as venues for the meeting.

Following the identification of venues, the method generates a set of suggested conversational topics. To do this, the method utilizes a mathematical function to identify the subset of available conversation topics with the highest likelihood of facilitating a positive short-term interaction, and repeated long-term interactions for the pair. In general, conversational topics that are related to a shared interest of the pair are favored. Following the identification of the venue, the method sends a digital notification to the user pair, introducing them, and relaying one or more suggested times to meet, one or more suggested venues, and one or more suggested conversation topics.

Upon meeting, the pairs of users may optionally enable the method to perform a real-time analysis of their social interaction through a button included in the digital introduction message, or through a web-interface. The real-time analysis produces discrete notifications which are sent to a user's digital device. The notifications attempt to maximize the probability of a “successful” social interaction. An interaction is deemed “successful” if it increases the probability of future positive interactions between the pair. The emotive polarity of the users is estimated by the method using a mathematical function which leverages data from one or more audio, visual, and physiological sensor technologies.

Notifications are issued to users on the basis of a causal analysis between a given user's linguistic and paralinguistic output, and the method's predicted success of the conversation. When the method detects sustained linguistic and/or paralinguistic content that is negatively associated with conversation success, a cautionary notification is issued to the party producing the offending linguistic and/or paralinguistic content. Similarly, linguistic and/or paralinguistic content that is associated with an increased probability of repeated future interactions, would issue an encouraging notification to the party producing the successful linguistic or paralinguistic content. For example, if one user is speaking in a tone that is associated with a negative emotional polarity, and the method predicts a decrease in the probability of future iterations, a cautionary notification would be issued. If the same user was speaking in the same tone, but the probability of future interaction was predicted to increase, an encouraging notification would be issued.

Following the meeting, the pair of users may choose to retrospectively report the quality of the method's introduction using structured (e.g. email questionnaire) and/or unstructured (e.g. free-text entry) means. This assessment is then utilized by the method to update its understanding of each user's optimal future introductions. Using a web-interface, users may also review retrospective assessments of their prior introductions. Retrospective assessments include conversational transcripts, an overall estimate of conversation success, linguistic content most strongly associated with increased and/or decreased conversational success, and specific suggestions to improve the success of subsequent meetings.

### BRIEF DESCRIPTION OF THE SEVERAL VIEWS OF THE DRAWINGS

The embodiments of the present invention are illustrated by way of example in, and not limited to, the following figures:

FIG. 1 provides a high-level overview of the invented method.

FIG. 2 is an exemplary depiction explaining how the method identifies the pairs of users most optimally suited for an introduction.

FIG. 3 is an exemplary depiction explaining how the method scores a specific pair of users for an introduction.

FIG. 4 is an exemplary depiction explaining how the method identifies venues suggestions that are provided to users.

FIG. 5 is an exemplary depiction explaining how the method identifies conversation topics that are provided to users.

FIG. 6 is an exemplary depiction explaining how the method monitors, and provides feedback on, the real-time interaction between the users.

### DETAILED DESCRIPTION OF THE INVENTION

The invention will now be more fully described, with reference to the accompanying figures. These figures formalize an exemplary instantiation of the invention, and describe how it may be used. The invention may be implemented in multiple ways, as software, hardware, or a combination of both software and hardware. Therefore, the invention is not limited to a single form and the following descriptions and figures are not intended to limit the invention to a single form, instantiation, or implementation.

As used herein, the term “social network” will refer to one or more individuals that are known to a given individual either physically (as a friend, spouse, colleague, etc.) or virtually (as part of a friends list, c-mail contacts list, etc.). As used herein, the term “platonic” refers to a interaction that is not a romantic pursuit, this may be, but is not limited to interactions for friendship, work, and mentorship. As used herein, the term “successful interaction” refers to an interaction that increases the probability of future interactions that have a positive nature.

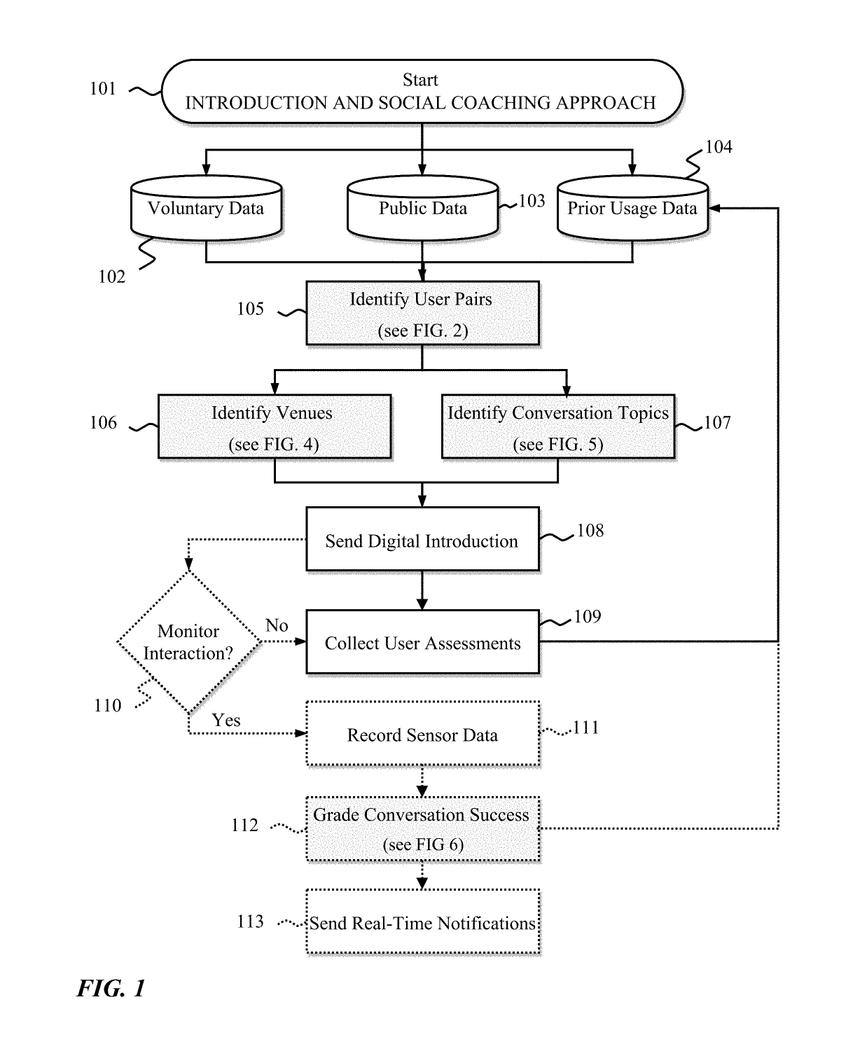

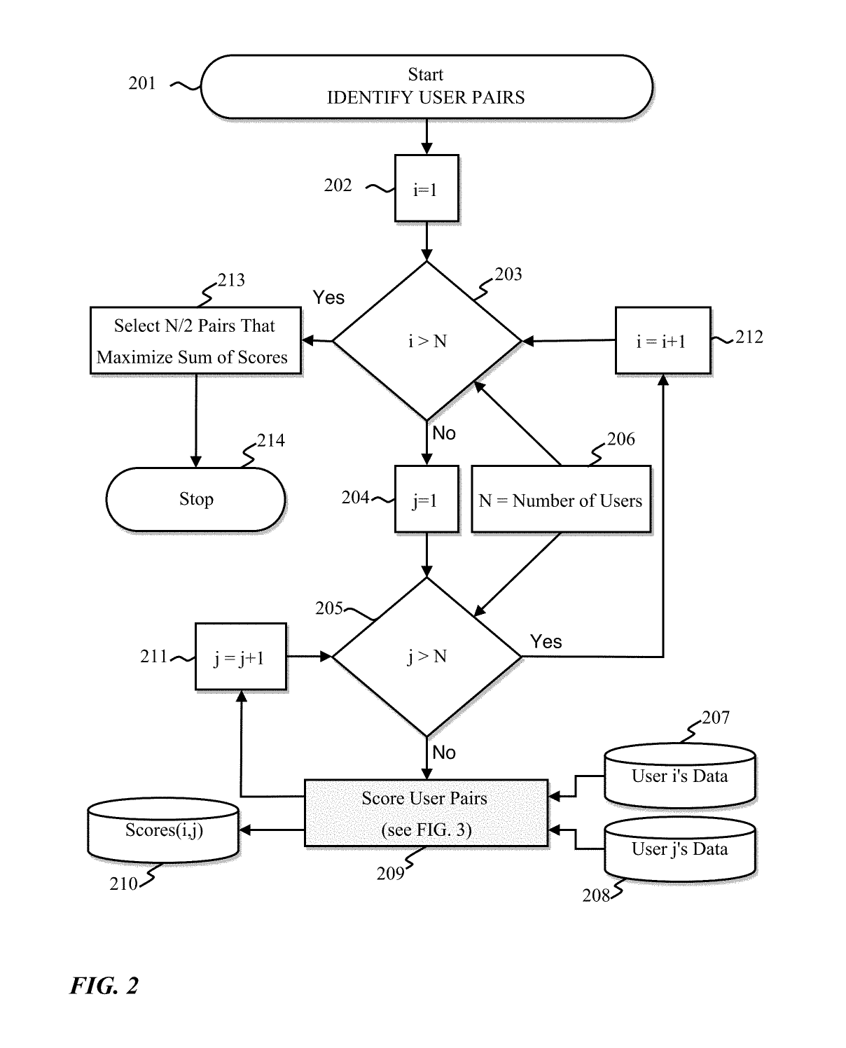

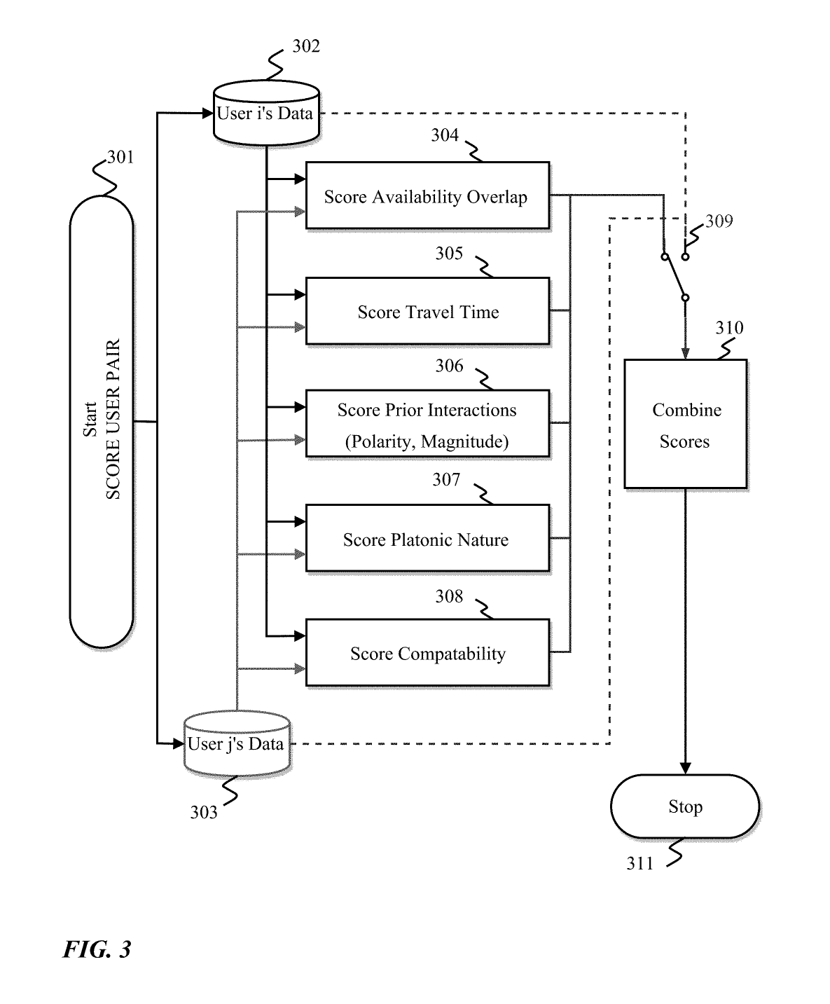

FIG. 1 provides a high-level overview of the invented method. The method generates introductions and provides social coaching to individuals (101). To generate introductions, the methods draws on: information volunteered by users (102), publicly available descriptions of users (103), and information about users' reactions to prior introductions made by the method (104). Using all available data (102-104), the method identifies pairs of users to introduce that are not within each other's social networks, but are likely to have a successful interaction if introduced (105, the precise mechanism of pair selection is described later, accompanying the description of FIG. 2 and FIG. 3).

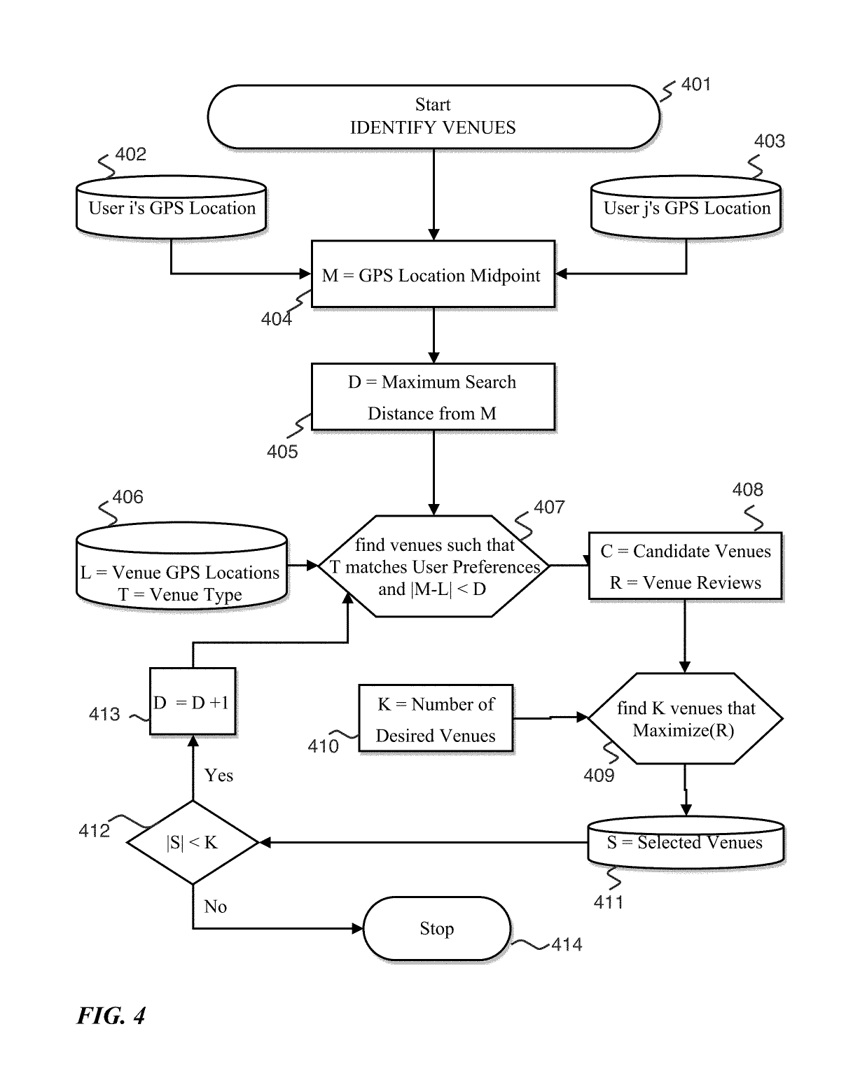

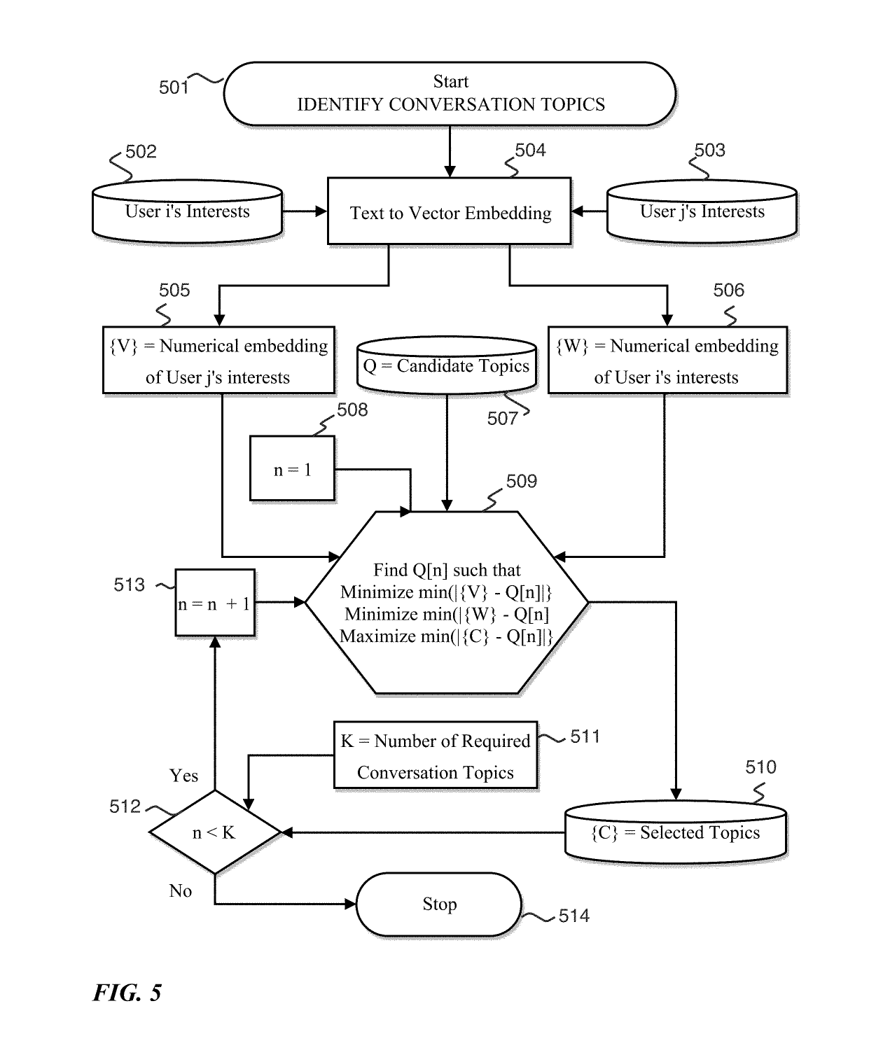

Next, for each identified pair, one or more venues (coffee shops, restaurants, parks, etc.) that will contribute to a successful interaction are selected to suggest as potential meeting locations (106, the precise mechanism of venue recommendation is described later, accompanying the description of FIG. 4). Furthermore, for each identified pair, one or more conversation topics that will contribute to a successful interaction are selected to suggest as potential conversational topics (107, the precise mechanism of topic recommendation is described later, accompanying the description of FIG. 5).

For each pair of users identified by 105, a digital message is generated (108). The digital introduction contains (1) a brief introductory message, (2) a list of suggested venues, (3) a list of suggested conversation topics, (4) a hyper-linked button allowing users to log that a connection could not be scheduled (109), (5) a hyper-linked button, allowing users to request that their upcoming interactions be monitored and coached (110), (6) a hyper-linked button, allowing users to log that they met the other party, and submit feedback on the interaction (111). If one of the users indicates that they are unable to schedule a connection (109), a record of this is made in the prior usage data (104), and the remaining user is re-introduced via 105. Pairs that are free to connect may optionally enable the invention to monitor their interactions (110), which enables the invention to record sensor data (112) to grade the success of the conversation (113), and provide real-time feedback (114).

FIG. 2 provides an illustrative depiction of the algorithm used to identify user pairs (201). Let N denote the number of users (206), and let i (202) and j (204) denote two particular users under consideration for pairing. The algorithm iterates over all possible users pairings (211, 212), and scores the probability of a successful interaction (209) between each pair, using any data available on the two users (207,208). The computed scores are saved in a database (210) that is updated, as required. Following the scoring of all user pairs (203, i>N), the N/2 pairs that maximize the sum of scores (213) in the scores database (210) are selected before completion (214). The scoring of user pairs may be parallelized to enhance the computational performance of the algorithm. For pairing problems with limited computational resources, the algorithm will randomly select values of i, and j and generate pair scores. If the score exceeds a given threshold, the two users will be paired and removed from further consideration.

FIG. 3 provides an illustrative depiction of the algorithm used to score a given pair of users (301). Here again, i and j denote two particular users that we wish to score, for which pertinent data is available (302,303). To begin, the algorithm utilizes the overlapping temporal availability of the pair to estimate the probability of a successful interaction (304).

A given user's availability is encoded with a binary matrix A_{t×d}, where d denotes the number of days, t denotes a particular continuous block of time during the day. Here a_{x,y} denotes the availability of a user on day y, at time x, while aₓ_{ₗ}_{:x}_{ᵤ}_{,y} denotes the availability vector of a user on day y, from time xₗ to xᵤ. Let us denote a vector of m historical user assessments of their interactions (109), stored in the prior usage data (104) as r_{m×l}. Let pᵢ denote the subset of assessments in r that were generated by user i. Let W_{A,i}∈ [symbol] ^{t×d} denote a matrix of weights that describes the best times for a match, for subject i, where w_{x,y}=0 ∀a_{x,y}=0. We identify the value of the weights through optimization of the following function:

$$arg {min}_{{W}_{A , i} , {β}_{A} , {θ}_{A}} \{ {β}_{A , 0} {\sum }_{i = m \vert m ∉ {p}_{i}} \vert {r}_{i} - f [ A \vert {W}_{A , i} , {θ}_{A} ] \vert + {β}_{A , 1} {\sum }_{i = m \vert m ∈ {p}_{i}} \vert {r}_{i} - f [ A \vert {W}_{A , i} , {θ}_{A} ] \vert \}$$

where β_{A,0} and β_{A,1} respectively describe the relative importance of the data from the population and the individual user in question, θ_{A}∈Z⁺ describes the total number of model parameters, for a topologically flexible multilayer neural network, and where f[A|W_{A,i},θ_{A}] is the scoring function (304) that estimates the probability of a successful interaction, given a user's availability A, and estimated weights matrix, W_{A,i}. The precise form of f[A|W_{A,i},θ_{A}] is likely to change given m. Specifically, the size of θ is constrained such that θ_{A}<m/s. Here s describes a parameter that controls the minimum number of historical user assessments required to add one additional parameter to the model. When θ_{A}=0, weights are selected uniformly, when θ>0, f[A|W_{A,i},θ_{A}] is allowed to use up to θ parameters to identify Wᵢ.

Upon identification of the weights for user i,W_{A,i}, the same process may be applied to identify the weight for user j, W_{A,j}. Next, a final matrix describing the temporal overlap of the pair is computed as V=W_{A,i}⊙W_{A,j}. Finally, the availability overlap score is determined by computing 1_{1×t}V_{t×d}1_{d×1}. Lastly, k time-day tuples that index the top elements from V are selected as suggested meeting times for the user pair.

After scoring the availability overlap between the pair, the method employs a similar approach to score the effects of travel time on interaction success (305). Let us denote the travel time of a given user, i, as dᵢ. the method estimates the probability of a successful interaction for each individual, as a function of the distance traveled to meet their match, using historic assessment and travel information. Similar to the approach in 304, the form and parameters of the function that estimates this probability are determined via optimization:

$$arg {min}_{{W}_{d , i} , {β}_{d} , {θ}_{d}} \{ {β}_{d , 0} {\sum }_{i = m \vert m ∉ {p}_{i}} \vert {r}_{i} - f [ {d}_{i} \vert {W}_{d , i} , {θ}_{d} ] \vert + {β}_{d , 1} {\sum }_{i = m \vert m ∈ {p}_{i}} \vert {r}_{i} - f [ {d}_{i} \vert {W}_{d , i} , {θ}_{d} ] \vert \}$$

where the values of θ_{d}, β_{d}, and W_{d} are analogous to those used to compute the availability overlap score (304). Upon identification of the weights for user i, W_{d,i}, the same process may be applied to identify the weight for user j, W_{d,j}. Finally, the travel time score is determined by computing

f[dᵥ/2|W_{d,j},θ_{d}]+f[dᵥ/2|W_{d,i},θ_{d}]

where dᵥ is the distance between the pair.

Next, the method scores the prior interactions between the pair (306). We denote the total number of observed prior interactions between the pair as h, the ratings of user i on user j as r_{i→j}∈[−1,1]⊂ [symbol] ^{h}, the ratings of user j on user i as r_{j→i}∈[−1,1]∈ [symbol] ^{h}. Let r_{i→j}^{(k)} describe the ratings of the kth interaction between user i and j. A function that predicts the success of a future interaction, given prior interactions between the user pair, is generated via optimization:

$$arg {min}_{{W}_{h , i} , {β}_{h} , {θ}_{h}} \{ {β}_{h , 0} {\sum }_{y = j ∉ N} {\sum }_{x ∈ h} \vert {r}_{i \to y}^{( x )} - f [ {r}_{i \to y}^{( 1 : x - 1 )} \vert {W}_{h , i} , {θ}_{h} \vert ] + {β}_{h , 1} {\sum }_{x ∈ h} \vert {r}_{i \to j}^{( x )} - f [ {r}_{i \to j}^{( 1 : x - 1 )} \vert {W}_{h , i} ] \}$$

Where the values of θₕ, βₕ, and Wₕ are analogous to those used to compute the availability overlap score (304). Following optimization, the score of prior interactions is specified by:

(f[r_{i→j}^{(1:x-1)}|W_{h,i}θₕ|]×f[r_{j→i}^{(1:x-1)}|W_{h,i}θₕ|])−gₕ[h|γₕ]

where γₕ describes the parameters of a penalty function gₕ that grows monotonically with h.

Next, the method scores the likelihood of a platonic interaction between the pair (307). We denote the platonic attraction of user i towards user j as l_{i→j}∈[−1,1]⊂ [symbol] ^{h}. A function that predicts the platonic nature of an interaction, given existing levels levels of romantic interest between the user pair, and the user's general level of romantic interest in the population is generated via optimization:

$$arg {min}_{{W}_{l , i} , {β}_{l} , {θ}_{l}} \{ {β}_{l , 0} {\sum }_{y = j ∉ N} {\sum }_{x ∈ h} \vert {l}_{i \to y}^{( x )} - f [ {l}_{i \to y}^{( 1 : x - 1 )} \vert {W}_{l , i} , {θ}_{l} \vert ] + {β}_{l , 1} {\sum }_{x ∈ h} \vert {l}_{i \to j}^{( x )} - f [ {l}_{i \to j}^{( 1 : x - 1 )} \vert {W}_{l , i} ] \}$$

The values of θₗ, βₗ, and Wₗ are analogous to those used to compute the availability overlap score (304). Following this optimization, the final score of platonic attraction is specified by:

(f[l_{i→j}^{(1:x-1)}|W_{l,i},θₗ|]×f[l_{j→i}^{(1:x-1)}|W_{l,i},θₗ|])−g[ϕ|γₗ]

where γₗ describes the parameters of a penalty function gₗ that grows monotonically with ϕ, and ϕ∈Z⁺ describes the number of times that the user has been reported for flirtatious behavior.

Next, the method scores the compatibility between the user pair (308). A given user's personal profile (such as profession, hobbies, skills) is encoded with a matrix B_{N×c}, where c denotes the number of profile elements available, and N denotes the total number of users. Let W_{c,i}∈ [symbol] ^{c} denote a vector of weights that describe the association between profile elements in B, and the probability of a successfull interaction. We identify the value of these weights for each user through optimization of the following function:

$$arg {min}_{{W}_{c , i} , {β}_{c} , {θ}_{c}} \{ {β}_{c , 0} {\sum }_{i = m \vert m ∉ {p}_{i}} \vert {r}_{i} - f [ {B}_{i} \vert {W}_{c , i} , {θ}_{c} ] \vert + {β}_{c , 1} {\sum }_{i = m \vert m ∈ {p}_{i}} \vert {r}_{i} - f [ {B}_{i} \vert {W}_{c , i} , {θ}_{c} ] \vert \}$$

The values of θ_{c}, β_{c}, and W_{c} are analogous to those used to compute the availability overlap score (304). Upon identification of the weights for user i, W_{c,i}, the same process may be applied to identify the weight for user j, W_{c,j}. The final score of user compatibility is then computed through:

f[Bⱼ|W_{c,i},θ_{c}]|×f[Bᵢ|W_{c,j},θ_{c}]|

After computing all first order scores (304-308), the method intelligently combines scores to deliver a final estimate of the probability of a successful interaction. We denote the set of all first order scores as S. We generate a final, combined score by minimizing the function

argmin_{ω}|rᵢ−f[S|ω]|

where ω denote the weights of the first order scores, and f is a sigmoid function. Given large data volumes, the method may jointly optimize all first order scores in 310 by leveraging the switch in 309. Upon completion of scoring, the method returns the score for the user pair (311).

FIG. 4 provides an illustrative depiction of the algorithm that identifies the venues (such as restaurants, cafes or parks) as suggestions for places users may go to meet in-person (401). Here again, let i and j denote the pair of users for which a venue suggestion is required. Their location information is stored in databases as represented by 402 and 403 for users i and j respectively. Their current GPS location, as well as their location history (pattern, movement, etc.) are considered, with a midpoint M used to represent the optimal distance between the users to meet (404). Next a search radius is determined (405), denoted D, in which to search for candidate venues. Let L denote the GPS location of venues, and let T denote the venue type, both of which are stored in a database (406). Candidate venues are selected in 407 if T satisfies user preferences, and is within the search radius (|M−L|<D). Once the candidate venues, denoted as C, have been shortlisted, venue reviews, as denoted by R, are generated (by public reviews, user history, etc.) in 408. The K venues (410) with maximal corresponding values of R (409) are selected. These selected venues, as denoted by S, are stored in 411. If less than K venues were identified 412, the distance search criteria D is incremented in 413, and the search for candidate venues that satisfy the distance criterion, user preferences, and ratings continues. Upon identification of K venues, the resulting selected venues are returned (414) to facilitate the introduction between users.

FIG. 5 provides an illustrative depiction of the algorithm that identifies the conversation topics to be sent to the users being introduced 501. Here again, let i and j denote the pair of users for which conversation topics are required. Databases 502 and 503 contain the interests of users i and j respectively. Each interest in the set of interests is converted into a vector representation using a nonlinear mathematical transform 504. This list of vector representations (or numerical embeddings), are denoted V for user i and W for user j. From the set of candidate topics Q (507), K topics (511) are iteratively selected (508, 512, 513). A each iteration, a candidate topic (in vector representation) is selected using 509, which seeks a topic that is minimally distant from the closest joint interest in V and W, while also being maximally distant from the set of topics selected in prior iterations (denoted by C, (510). Once completed, the topics are returned (514) facilitating the introduction between users.

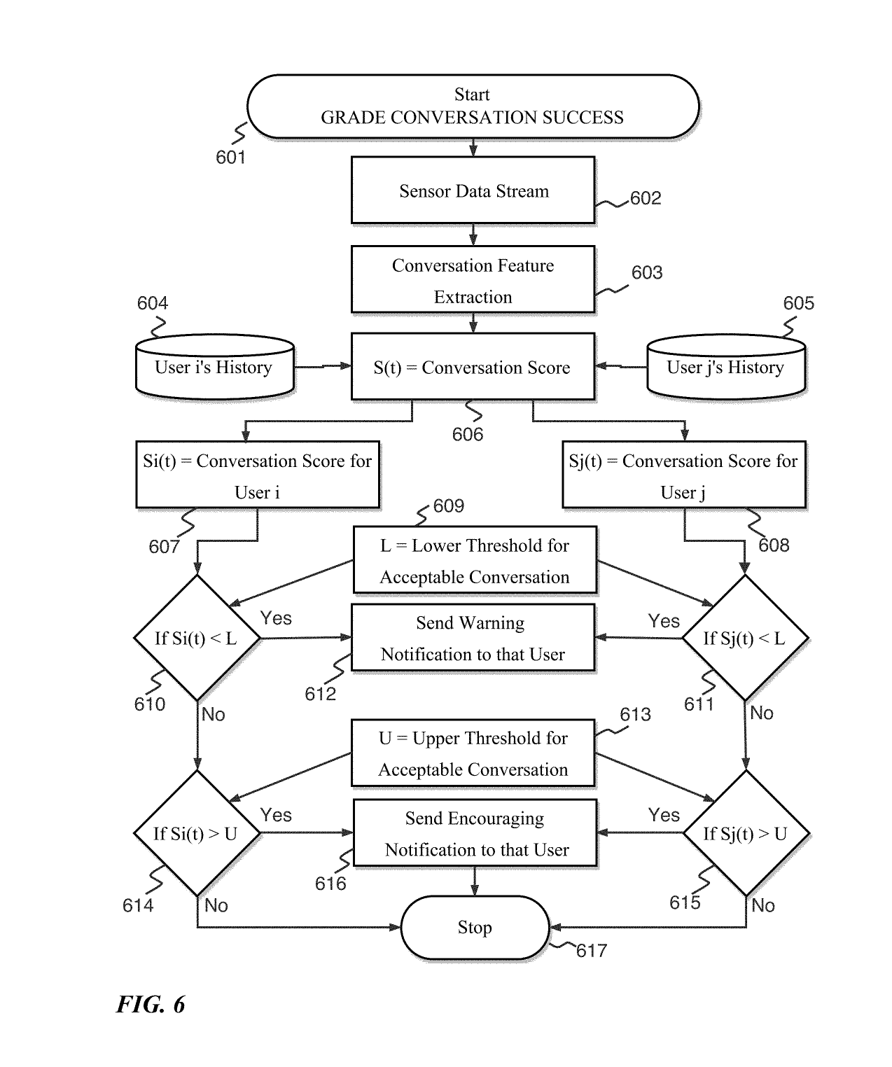

FIG. 6 provides an illustrative depiction of the algorithm that grades a conversation between two individuals (601). During a social interaction a stream of one or more sensory data (602, such as audio, text-transcriptions, or heart-rate) are measured. From these streams a set of features are extracted (603, including pitch, speaking rate, variance in heart-rate). These features are combined with information on the user's history (604 and 605, such as their personal interaction model, past user ratings, public profile, etc.) to generate a real-time estimate of conversational success (606).

Let π denote the set of sensor data streams collected (602). Let M denote the total number of meetings. Let μ denote the set of historic information available on user's interactions. Let f_{1:z}′[π,μ] denote a set of z mathematical transforms of π and μ, denoted “features”. Let W_{S} denote the weights of a multilayer neural network which uses the extracted features estimates over time to predict the probability of a positive or negative user state, S(t, f_{1:z}′[π,μ]) (606). Let rₘ denote the probability that a user will arrange another meeting following the conclusion of the current meeting, m. Let θ_{S} denote the topological configuration of the multilayer neural network (number of layers, number of nodes, etc.). We seek to determine the values of W_{S} and θ_{S} that allow S to predict r. These values are determined through optimization:

$$arg {min}_{{W}_{S} , {θ}_{S}} \{ {\sum }_{i ∈ M} \vert {r}_{ι} - S ( t , {f}_{1 : z}^{′} [ {π}_{i} , {μ}_{i} ] \vert {W}_{S} , {θ}_{S} ) \vert \}$$

The scoring function, S, may then be used to predict the probability of a future meeting, given a sensor data streams and usage history.

Using the identified scoring function, scores for each user are generated (607 and 608) which are then evaluated against thresholds of acceptable conversation. 610 checks whether the conversation score for user i is below the lower threshold L (609) and if so, a notification is sent to user i (such as by SMS, device vibration) to inform them that the interaction could be improved (612). If the interaction is above the upper threshold, U (613), for user i (614), then a notification (616) is sent to user i encouraging them to continue with their current conversational approach. If the conversation score is above L but still below U, then no notification is sent (617). The same computation and pipeline conducted for user i is conducted for user j in 611 and 615.

What is claimed:

1. A method of suggesting non-romantic interactions between two or more previously unacquainted entities that jointly maximizes the entities' short-term positive interactions and long-term repeated interactions by intelligently weighting scores comprising one or more of:
a. individualized scores of overlapping temporal availabilities between two or more entities;
b. individualized scores of estimated travel times required for two or more entities to interact;
c. individualized scores of the polarity and magnitude of prior interactions between two or more entities;
d. individualized scores of romantic interest between two or more entities; or
e. individualized scores of personal compatibility between two or more entities,
wherein the individualized scores weighted by the method are themselves comprised of weighted combinations of aspects of two or more entities, and where all weights are determined through the optimization of a multilayer neural network with topological characteristics and model parameters identified using a database that curates aspects of two or more entities determined based on one or more of:
a. such entity's responses to one or more inquiries;
b. such entity's historic interactions with one or more other entities; or
c. such entity's public domain activities
and where the means of inquiry used to collect aspects of entities are through one or more of:
a. direct oral communication with an entity;
b. indirect oral communication with an entity;
c. direct digital communication with an entity;
d. indirect digital communication with an entity; or
e. inspection of publicly available digital and non-digital information sources.

2. A system that uses the method of claim 1 to digitally arrange interactions between two or more entities by sending a digital message comprising one or more of:
a. content introducing the entities;
b. a list of one or more suggested interaction times;
c. a list of one or more suggested interaction venues;
d. a list of one or more suggested conversation topics;
e. a button allowing entities to provide feedback;
f. a button allowing entities to indicate an inability to schedule an interact;
g. a button allowing entities to log their interaction; or
h. a button allowing entities to request real-time monitoring of their social interaction
wherein the suggested conversational topics are determined by identifying:
a. topic(s) which are both maximally diverse; and
b. topic(s) of greatest joint interest to the entities
and wherein the suggested meeting venues of entities are generated by using the locations of the entities to determine:
a. venue(s) that satisfy the preferences of the entities;
b. venue(s) that jointly minimize the entities' travel time;
c. venue(s) that jointly maximize the entities' historical ratings of the venue; and
d. venue(s) that maximize historical ratings according to publicly available assessments.

3. A system that performs real-time monitoring and analysis of one or more entity interactions, arranged by claim 2, using one or more sensor technologies, comprised of:
a. a function to extract features from data stream(s);
b. a function to generate individualized scores of real-time interaction success; and
c. digital notification(s) to the participating entities.
wherein the individualized scores of real-time interactions are composed of one or more weighted combinations of aspects of two or more entities, and where all weights are determined through the optimization of a multilayer neural network with topological characteristics and model parameters identified using a database that curates aspects of two or more entities determined based on one or more of:
a. the entity's responses to one or more inquiries;
b. such entity's historic interactions with one or more other entities;
c. such entity's public domain activities; or
d. such entity's technology sensor profile.
wherein the digital notification(s) may be comprised of one or more of:
a. a description of the state of the interaction;
b. a prescription of the action to be taken by the entity to improve the interaction.
